(19) United States
(12) Patent Application Publication
(10) Pub. No.: US 2025/0355995 A1
(43) Pub. Date: Nov. 20, 2025

(54) HYPERCONTAINER SYSTEM

(71) Applicant: PureCipher Inc., Boca Raton, FL (US)

(72) Inventors: Wendy Chin, New York, NY (US); William Hahn, Delray Beach, FL (US); Prajwal Nagaraj, Delray Beach, FL (US); Mykyta Storozhenko, Boca Raton, FL (US)

(21) Appl. No.: 19/208,901

(22) Filed: May 15, 2025

Related U.S. Application Data
(60) Provisional application No. 63/648,392, filed on May 16, 2024.

(51) Int. Cl. G06F 21/53

(52) U.S. Cl. CPC G06F 21/53; G06F 2221/033

(57) ABSTRACT

Systems and methods are disclosed for implementing a secure hypercontainer system for containerized applications. In an embodiment, a method may comprise executing a hypercontainer system including an encapsulated software application environment having built-in intelligent security features. The method may include receiving a request for processing by an application hosted at the hypercontainer system in a first intelligent data container (IDC), the first IDC including software container executing the application, evaluating the request via a mini security manager integrated in the first IDC to determine if the request includes a security threat, rejecting the request without processing by the application when the request includes the security threat, and processing the request by the application and returning a response when the request does not include the security threat.

### CROSS-REFERENCE TO RELATED APPLICATION

The present application claims priority to pending U.S. provisional patent application, Application No. 63/648,392, filed May 16, 2024, entitled “Hypercontainer System”, the contents of which are hereby incorporated by reference in their entirety.

### TECHNICAL FIELD

Various embodiments of the present technology generally relate to secure software environments. More specifically, embodiments of the present technology relate to systems and methods for improved security at containerized application environments.

### BACKGROUND

Hosted software applications, such as within encapsulated software environments, may be used to provide a wide variety of services, including back-end business operations and customer-facing utility. Malicious attacks or unintended access operations to hosted software can negatively impact the hosted software itself, the privacy of hosted data, or the quality of client services, among other considerations. Securely hosting applications is therefore important to protect the integrity of business infrastructure, the quality of application output, service uptime, proper data access rights, and other application considerations. There is a divergence between security encapsulation techniques when it comes to running and hosting secure applications, each with their own shortcomings.

One approach may be to instantiate a virtual machine (VM) on a host system in order to run the application. However, this approach may be costly, in that the resources necessary to instantiate separate VMs on a host system create significant overheard over time. For scenarios where only a single application needs to be securely isolated, this may result in unnecessary duplication of system resources and inefficiency.

Another approach is to instantiate a container, or a collection thereof, on a host system. This approach avoids the doubling of the host system by sharing the kernel of the host system, along with the system resources. A container can be thought of as an executable environment that merely virtualizes the highest level of an OS, while relying on the host system for the underlying resources. This allows for a very efficient computation, but at the cost of security. The problem with containers may be that they share, among other resources, memory with the host system. Potentially, an agent could install a memory monitor on the host system that reads the contents of the memory addresses that a container is using, hence defeating the security of the container.

As such, there is a fork in the road. An application could be hosted inside a VM, but the computational overhead is significant, coupled with compatibility issues and the overall complexity of hosting virtual machines inside a host machine. As an alternative, an application could be hosted inside a traditional container, yet doing so poses security issues such as memory-vulnerability attacks and unauthorized use.

Worse yet, both VMs and traditional containers lack embedded security features that leverage advanced technology to prevent data tampering, unauthorized access, leaks, and other attacks. Often, both VMs and containers rely on the hosted application to handle security vulnerabilities pertaining to hacking attacks, while featuring no security features themselves. This can create a large attack surface that may spill beyond the application and affect the whole system. Accordingly, there exists a need for improved application hosting within a secure, encapsulated environment.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing a hypercontainer system. In an embodiment, a method may comprise executing a hypercontainer system including an encapsulated software application environment having built-in intelligent security features. The method may include receiving a request for processing by an application hosted at the hypercontainer system in a first intelligent data container (IDC), the first IDC including software container executing the application, evaluating the request via a mini security manager integrated in the first IDC to determine if the request includes a security threat, rejecting the request without processing by the application when the request includes the security threat, and processing the request by the application and returning a response when the request does not include the security threat.

In certain embodiments, a memory device may store instructions that, when executed, cause a processor to execute a hypercontainer system including an encapsulated software application environment having built-in intelligent security features. The processor may receive a request for processing by an application hosted at the hypercontainer system in a first intelligent data container (IDC), the first IDC including software container executing the application, evaluate the request via a mini security manager integrated in the first IDC to determine if the request includes a security threat, reject the request without processing by the application when the request includes the security threat, and process the request by the application and return a response when the request does not include the security threat.

In certain embodiments, an apparatus comprising a processor, and a memory device storing instructions that cause the processor to execute a hypercontainer system including an encapsulated software application environment having built-in intelligent security features. The apparatus may receive a request for processing by an application hosted at the hypercontainer system in a first intelligent data container (IDC), the first IDC including software container executing the application, evaluate the request via a mini security manager integrated in the first IDC to determine if the request includes a security threat, reject the request without processing by the application when the request includes the security threat, and process the request by the application and return a response when the request does not include the security threat.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement a hypercontainer system, in accordance with certain embodiments of the present disclosure;

FIG. 2 is a diagram of a system configured to implement a hypercontainer system, in accordance with certain embodiments of the present disclosure;

FIG. 3 depicts a flow diagram of an example method to implement a hypercontainer system, in accordance with certain embodiments of the present disclosure;

FIG. 4 depicts a flow diagram of an example method to implement a hypercontainer system, in accordance with certain embodiments of the present disclosure;

FIG. 5 depicts a flowchart of an example method to implement a hypercontainer system, in accordance with certain embodiments of the present disclosure; and

FIG. 6 is a diagram of a system configured to implement a hypercontainer system, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

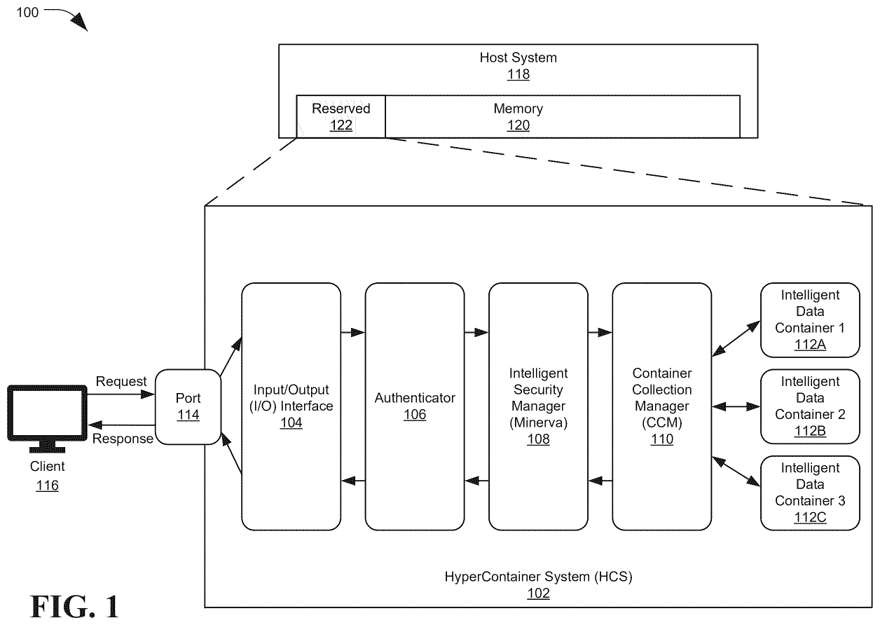

FIG. 1 is a diagram of a system 100 configured to implement a hypercontainer system, in accordance with certain embodiments of the present disclosure. The system 100 may include an example implementation of an encapsulated software application environment having onboard or built-in intelligent security features, such as an artificial immune system (AIS), generally referred to herein as a hypercontainer. A hypercontainer system (HCS) may be a software container environment that allows for the secure, isolated instantiation of containerized applications. The system 100 may include a client system 116, a host system 118, and an HCS 102 executed by host system 118.

Each or any of client 116, host 118 and its components, HCS 102 and its components, or the one or more network connections and interfaces via which client 116 may communicate with host 118 and HCS 102 may be implemented via computers, servers, hardware and software modules, or other system components. The elements of system 100, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

Client 116 may be a program or an end-user that submits request messages (e.g., over a wired or wireless connection) to HCS 102 at host system 118. The requests may include computer messages including data for processing, an indication of a type of processing requested or target application to perform the processing, or other elements. When a request has been processed, the client 116 may receive a response including the results of the processing. Client 116 may include a device, system, or module, such as a server, desktop or laptop computer, smartphone, tablet, modems, vehicles, televisions or set-top boxes, smart home devices, voice over IP (VOIP) devices, internet of things (IoT) devices, or any and all other systems that may make requests to a hosted application.

Host system 118 may include one or more computers, servers, or other physical computing devices configured to implement an HCS 102. For example, host 118 may include a single server device, or multiple server devices providing resources in a cloud environment. Host 118 may include one or more computing resources, such as memory 120. The memory 120 of host system 118 may have addressable units of physical memory capacity used to run the host operating system (OS), applications, and other resources. In the depicted example, host system 118 executes HCS 102 by allocating a reserved 122 address range of memory 120 for use exclusively by the HCS 102. By setting aside the reserved 122 address range for use by the HCS 102 only, the HCS 102 may be protected from tampering with its memory usage when running applications securely.

HCS 102 may be a lightweight, custom, locked-down container designed to encapsulate software artifacts together, and utilizing a separate and protected memory space 122. HCS 102 may leverage the minimal computational overhead of traditional containers and the full level isolation of virtual machines, while integrating an intelligent security manager (ISM, sometimes referred to as ‘Minerva’) 108, which may take the form of an artificial intelligence (AI)-driven monitoring system or artificial immune system (AIS). By leveraging the intelligent security manager 108, HCS 102 can vigilantly oversee all operational data, enhancing security by detecting and responding to anomalies in real-time, thus providing a robust, efficient, and secure hosting environment. HCS may instantiate containerize applications using intelligent data containers (IDCs) 112, which may themselves be containers that include intelligent security features.

In order to avoid the issues with both VMs and traditional containers, HCS 102 may use a custom runtime that permits the separation of reserved memory 122 and other host 118 resources without the overhead of a VM. The HCS 102 may be set up in such a way so as to harness the benefits of full isolation with minimal overhead comparable to a traditional container. HCS 102 can be hosted over networks or locally. HCS 102 may include multiple components, including an input/output (I/O) interface 104 which may be accessed via a specific exposed port 114, an authentication or authenticator module 106, the intelligent security manager (ISM) 108, a container collection manager (CCM) 110, and one or more intelligent data containers (IDCs) 112, such as IDC1 112A, IDC2 112B, and IDC3 112C.

HCS 120 may achieve security via separation and restriction of internal components. Inside the HCS 120 may be a customized operating system that is set up in a way that restricts access solely to the I/O interface 104. A traditional container may be accessed via a command line interface (CLI) or other access methods. However, after the initial set-up, the only way to access HCS 102 and the encompassed IDC 112 may be via the I/O interface 104 and on a specific port 114. By limiting request and responses to the specified port 114 and I/O interface 104, HCS 102 can more carefully control the types of requests and messages it will consider or receive. The I/O interface 104 can be configured based on user needs to accept HTTP(S) (hypertext transfer protocol (secure)) or(S) FTP (secure shell (SSH) file transfer protocol) requests, and to process and organize the request in a format that the use-case requires. The I/O interface 104 may be fixed in such a way so as to not access the payload of an incoming request, and to merely format the request and forward it to the authentication module 106. No component other than the authentication module 106 may have access to the I/O interface 104, thereby providing separation that improves security.

The Authentication module or layer 106 may receive the properly formatted request from the I/O interface 104 and ensures that the proper authentication credentials are present. For example, the authenticator 106 may verify that the request includes a proper security token, encryption protocol, password, or other security credentials required to grant access to HCS 102 or and IDC 112 or hosted application within. The authentication layer 106 may be use-case defined, and can be set up to reject most requests for the slightest abnormalities. Different authentication methods may be used as well, depending on the use-case requirement. The authentication module 106 may be isolated, connecting only to the I/O interface 104 and the ISM 108. Additionally, the authentication layer 106 may log all requests, and make the logs available to the intelligent security manager 108 for continuous learning and integration.

The ISM 108, or “Minerva”, may be the core of the security behind HCS 102. Using a combination of symbolic (e.g., rule-based deterministic algorithms) and connectionist (e.g., machine learning) artificial intelligence systems, the ISM 108 may examine all incoming, outgoing, and internal operations that HSC 102 is exposed to. ISM 108 may examine all incoming requests, evaluate them in accordance with a set of rules, run them through an internal AI model (e.g., a large language model, LLM), and then adjudicate whether they are safe requests or not. Should the request be malicious, ISM 108 may reject it, log all available information, and make the log available to the owner of HCS 102. Should the ISM 108 authorize the request, the ISM 108 may forward it to an appropriate IDC 112 (e.g., either directly or via CCM 110). The ISM 108 may also perform a similar review process on all outgoing responses, ensuring they conform with a security policy defined by the use-case. For example, the ISM 108 may check a response from a hosted AI chatbot to ensure the chatbot was not “tricked” into providing prohibited or protected information in its reply. All internal operations may be logged by ISM 108, so as to make auditing easier. The ISM 108 may act as a sole access point to all of the IDCs 112, and may therefore isolate them from the rest of the system, and may ensure the security of the application(s) running inside the HCS 102 as IDC(s) 112.

In some examples, ISM 108 may evaluate messaging and operations of the HCS 102 using both deterministic rule sets and transformer-based large language models (LLMs), trained on cybersecurity and system behavior data, to provide intelligent behavioral monitoring, threat detection, and adaptive response capabilities. ISM 108 may act as an artificial immune system (AIS), continuously monitor the runtime behavior of contained software for anomalies, intrusions, or deviations from policy. ISM 108 may integrate negative selection algorithms (NSA) and immunological pattern recognition principles to identify and neutralize even subtle abnormal system behaviors. ISM 108 may autonomously quarantine, mutate, or rollback software components in response to detected threats. ISM 108 may provide behavioral modeling, using probabilistic LLM models built on normal operation patterns. Using prompt-based learning or fine-tuned models, ISM 108 may perform threat classification, classifying emerging threats in real-time. Upon threat detection, ISM 108 may use natural language reasoning to generate a list of possible responses (e.g., alert, disconnect, kill process) and selects the optimal action. A machine learning (ML) layer of the ISM 108 may continuously learn and adapt, incorporating new behavior trends from operational data and updating threat models while retaining core behavioral boundaries. Learning can be local or federated, depending on the mission environment.

In operation, ISM 108 may receive requests in a structured format (e.g., command, source, time, target container). ISM 108 may capture contextual metadata such as user or session ID, origin and integrity of payload, and time-sensitive variables (e.g., time-to-live (TTL), mission mode). ISM 108 may perform rule-based evaluation, for example using symbolic AI, to evaluate requests using a defined rule engine. These rules may include access control rules (who can access what), time-based restrictions, command whitelists or blacklists, or container-specific permissions. Rules may be deterministic and enforced in real-time using a logic framework (e.g., Drools, Prolog, custom DSL). ISM 108 may also perform behavior analysis, for example using connectionist AI, to assess deeper risk. For example, it may check for anomalous patterns in access timing, frequency, or command structure, and compare requests against trained models for normal behavior profiles.

ISM 108 may output a confidence score of a request's trustworthiness. The ISM 108 may use a combination of symbolic and ML outputs to determine a final action to take. For example, the ISM 108 may allow a request and route it to a target IDC if the confidence score is above a first threshold, quarantine the request for manual review or escalation if the confidence score is below the first threshold but above a second threshold, or reject the request if the confidence score is below the second threshold. Requests that violate the deterministic ruleset may likewise be rejected or quarantined. Decisions may include a rationale for transparency (e.g., rule triggered, ML confidence level, anomaly markers).

ISM 108 may route approved requests to a correct child container (e.g., IDC1 112A, IDC2 112B, or IDC3 112C) through secure, pre-authorized channels. In some implementations, no direct peer-to-peer interaction may be allowed between containers, and only the ISM 108 may facilitate communication. For internal communication requests, the same security evaluation cycle may be repeated

HCS 102 may instantiate a single IDC 112 (e.g., IDC 1 112A) to run a single application, or it may instantiate several IDCs 112. The HCS 102 is flexible such that it can accommodate either use-case. The Container Collection Manager (CCM) 110 of the HyperContainer System may only be instantiated or utilized should there be more than one IDC 112 running inside HCS 102. The ISM 108, in this case, may use the CCM 110 to route requests to an appropriate IDC 112. In some implementations, the ISM 108 may determine which IDC 112 is appropriate for handling the request, and the CCM 110 may be used for simple routine, while in other embodiments the ISM 108 may forward cleared requests to the CCM 110, which may determine which IDC 112 is appropriate to handle the request and route the message accordingly. Should the IDCs 112 need to interact, the CCM 110 may route the communications, with or without the permission of the ISM 108. For example, if each IDM 112 includes an internal authorization and security module, CCM 110 may be able to route messages between them and rely on their internal security for ensuring messages are appropriate, without needing to send each message to ISM 108. In other examples, CCM 110 may have ISM 108 review inter-IDC 112 messages regardless of internal security modules at IDCs 112.

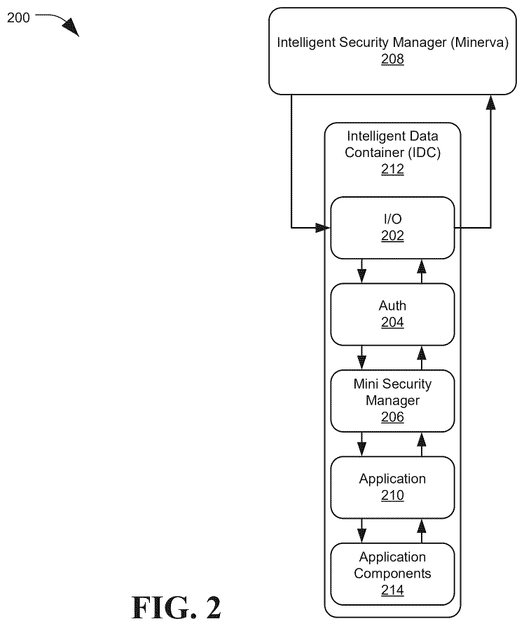

An Intelligent Data Container (IDC) 112 may be containerized applications that the HCS 102 instantiates, either singularly or in multiples. Within the container environment of HCS 102, each IDC 112 may be a container itself that encapsulates and hosts an application to run, and has embedded security features as well, providing maximal security for the entire system. IDC 112 may be hosted by the HCS 112, and the only point of contact for a hosted IDC 112 may be the ISM 108 (with or without CCM 110) residing within the HCS 102. IDC 112 may include metadata and policies defining acceptable behavior, update permissions, and access control rules, enforced by its own internal authorization and security manager modules. An example IDC 112 is presented in greater detail in regard to FIG. 2.

FIG. 2 is a diagram of a system 200 configured to implement a hypercontainer system, in accordance with certain embodiments of the present disclosure. In particular, system 200 illustrates an example implementation of an intelligent data container (IDC) 212 hosted within a hypercontainer system (HCS). Much like the HCS depicted in FIG. 1, the IDC 112 may contain a somewhat similar structure in regard to an input/output module (I/O) 202, an authorization module (“Auth”) 204, and a mini security manager (or “MinervaMini”) 206. Unlike the HCS, the IDC 112 may host the actual application 210 and any associated application components 214, the “what” of the IDC 112 and the reason it is set up.

The input and output (I/O) layer 202 may be the sole point of access for the IDC 212, via which requests may be received from an intelligent security manager (ISM) 208 (directly or via a container collection manager) of the hosting HCS. I/O 202 may process a request that has been forwarded by the ISM 208 and structure it for processing by the Auth layer 204.

The Auth layer 204 ensures that the request contains the right authorization, which may be a separate authorization check from that performed by authenticator 106 of the HCS 102. This can be beneficial, for example since the HCS can be set up to host several IDCs, and not all users may access all of the IDCs. The Auth layer 204 may be connected to the mini security manager 206.

The mini security manager 206 may be a miniaturized version of the ISM 108 of the HCS 102, and may perform a similar function, in the similar way, but specific to the IDC 112 in which it is running. For example, mini security manager 206 may be configured to meet the use-case specs of the client for the particular application 210 executed by the IDC 212, while the main ISM 108 of HCS 102 may be configured for general oversight of all of the hosted application IDCs. Mini security manager 206 may ensure that the application 210 receives requests that are appropriate to it, and returns information that is appropriate for the request. This can minimize the attack surface even further than the ISM 108 of the HCS 102 alone. The mini security manger 206 may be the sole point of access for the hosted application 210.

The application 210 may be the program module securely encapsulated by IDC 212. Application 210 can be a Relational Database Management System (RDBMS), a software application of any sort, an artificial intelligence model training or inference interface application, and even a system that powers a data lake, and so on. The application 210 may only interact with the mini security manager 206 and application components 214, being entirely isolated from any interaction otherwise, ensuring a high level of security. Ultimately, the application 210 may be use-case defined, and the IDC 112 may merely encapsulate it.

Application components 214 may be those subroutines, programs, libraries, or applications that the main application 210 calls upon to execute, e.g., via methods. An RDMBS may rely on methods that call scripts and hosts the data in files, while an AI training or inference interface may rely on a model and internal subroutines, and so on. The application components 214 may be isolated in that they only are accessed by the application 210 itself, and are inaccessible otherwise.

In short, the hypercontainer system (HCS) and intelligent data container (IDC) example architecture presented in this document offers a highly secure and efficient solution for hosting applications. By leveraging a custom runtime and a separate, protected memory space, the HCS can provide the benefits of full isolation with minimal overhead, comparable to traditional containers. The system's security is further enhanced by the separation and restriction of internal components, with the input/output interface serving as the sole access point to the HCS and IDC.

The intelligent security manager (ISM) or mini security manager may utilize a combination of symbolic and connectionist artificial intelligence systems, and may play a crucial role in examining all incoming, outgoing, and internal operations, ensuring the security of the application(s) running inside the HCS as IDC(s). The Container Collection Manager (CCM) may enable the routing of requests and communication between multiple IDCs, if necessary.

The IDC may be structured similarly to the HCS itself, in addition to hosting an application. The IDC itself encapsulates and hosts the application, with its own set of security features, including the mini security manager, which may perform functions similar to the ISM but is specific to the IDC. This multi-layered approach to security minimizes the attack surface and ensures that the application receives only appropriate requests and returns information that is suitable for the request.

The flexibility of the HCS and IDC architecture may allow for the hosting of various types of applications, such as Relational Database Management Systems, software applications, artificial intelligence model training or inference interface applications, and even systems that power data lakes. This adaptability makes the architecture suitable for a wide range of use cases, providing clients with a secure and efficient solution for their specific needs.

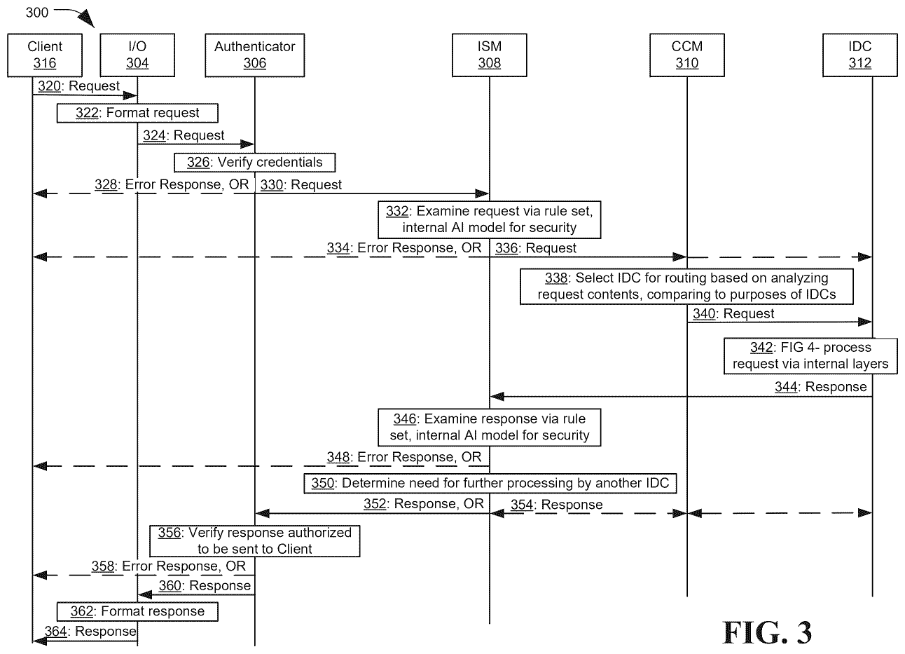

FIG. 3 depicts a flow diagram 300 of an example method to implement a hypercontainer system, in accordance with certain embodiments of the present disclosure. In particular, diagram 300 presents a functional overview of the HCS operational architecture, presented through an interaction flow. Diagram 300 may include a client 316, I/O interface 304, authenticator 306, intelligent security manager (ISM) 308, container collection manager (CCM) 310, and IDC 312, which may correspond to client 116, I/O interface 104, authenticator 106, ISM 108, CCM 110, and IDC 112 of FIG. 1, respectively.

At 320, the client 316 makes a request. The client 316, being a program or an end-user, makes a request to the HCS. The request may need to be formatted according to the Input/Output interface 304 specifications of the HCS. The structure of the request may be defined by the Input/Output interface 304 specifications of the HCS, which may be based on the specific use case requirements of the HCS or the hosted applications. In some examples, the request can be sent via HTTP(S) or(S) FTP, depending on the HCS configuration. After the client 316 sends the request, they may await a response.

At 322, the I/O 304 may receive the request, and may perform formatting operations on it. For example, a request may need to be received by I/O 304 in a proper or expected format, and from there I/O 304 may format it for further processing by the HCS. A properly formatted request may be received by I/O 304 through an exposed port, which may be the only access point to the HCS. I/O 304 may process and organize the request into a format required by the use case without accessing the payload of the request. For example, the I/O 304 may potentially decrypt the request message without reading the payload information, extract the payload data block from the request for further processing by the HCS, while potentially removing unnecessary header or other message format information, or perform other formatting operations. A properly formatted request may be forwarded to the authentication layer 306, at 324. If the request is improperly formatted when received by I/O 304, an error response may be sent back to the client 316.

At 326, the authentication layer 306 may validate the request. The authentication layer 306 may receive the formatted request from the I/O interface 304, and verify the authentication credentials provided in the request. The authentication method can vary based on the use case requirements (e.g., JSON web token (JWT), application programming interface (API) keys, username/password, etc.). The authentication layer 306 may log all requests and make the logs available to the ISM 308 for continuous learning and integration. If the credentials are valid, authenticator 306 may forward the request to the ISM 308 for further processing, at 330. If the credentials are invalid, an error response may be generated and sent back to the client 316 via the I/O interface 304, at 334.

At 332, the ISM 308 examines the request. The ISM 308, for example using symbolic and connectionist AI systems, may examine the incoming request. The ISM 308 may evaluate the request against a set of predefined security rules and runs it through an internal model to determine if it is safe. If the request is deemed safe, the ISM 308 may forward it to the appropriate IDC 312 for processing, at 336. If the HCS hosts a single IDC 312, the ISM 308 may directly forward the safe request to the IDC's 312 I/) layer for processing. If multiple IDCs 312 are present, the ISM 308 may use the CCM 310 to route the request to the appropriate IDC 312. If the ISM 308 determines the request is malicious or otherwise unsafe, it may be rejected, logged, and the information is made available to the owner or operator of the HCS. An error response may be generated and sent back to the client 316 via the authenticator 306 and I/O 304, at 334.

In embodiments where the HCS hosts multiple IDCs 312, the ISM 308 may forward the safe request to the CCM 310. The CCM 310 may be responsible for routing the request to the appropriate IDC 312 based on the request's content and the IDC's 312 purpose, at 338. In some embodiments, the ISM 308 may determine an appropriate IDC for handling the request by evaluating the request's content, and the CCM 310 may merely route the request to the specified IDC 312 based on the ISM's 308 instruction. In another example, the CCM 310 may be configured to analyze the request's content and determine the appropriate IDC 312 to handle the request based on the IDC's purpose and capabilities. In either event, the CCM 310 may route the request to the selected IDC's 312 Input/Output layer for further processing, at 340.

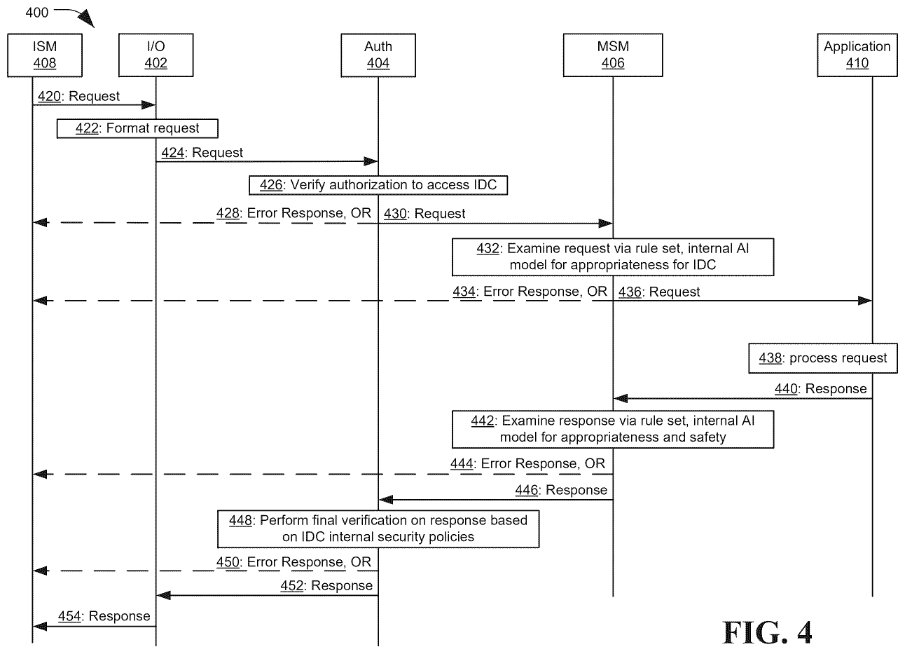

At 342, the IDC 312 may process the request via its internal layers, as described in greater detail in regard to FIG. 4. At 344, IDC 312 may provide a response to the ISM 308.

At 346, the ISM 308 may examine the response. The ISM 308 may receive the response from the IDC 312, and examine it using its symbolic and connectionist AI systems to ensure that it adheres to predefined security policies defined by the use case. For example, the ISM 308 may perform a check to make sure the response does not include sensitive or restricted information that should not be included in a response to a client 316. If the response fails the ISM's 308 security checks, an error response may be generated and sent back to the client 316 via the authentication layer 306 and I/O interface 304, at 348.

If the ISM 308 determines that the response does not violate its security check, the Ism 308 may determine if the response requires further processing by other IDCs 312, or if it is ready to be sent back to the client 316, at 350. For example, if the request included a multi-part or multi-aspect request that may require processing by multiple IDCs 312, then the response from a first IDC 312 may only provide a partial response, and further processing may be required before the response is complete. If the response requires further processing by other IDCs 312, the ISM 308 may send the response to the CCM 310 to route it to the appropriate IDC(s) 312, at 354. The CCM 310 may send the response to the relevant IDC(s) 312 for processing, repeating steps 342 through 346. Once all the necessary IDCs 312 have processed the response, the response may be sent back to the ISM 308 for a final examination. If the response is ready to be sent back to the client 316 and passes the ISM's 308 security checks, it is forwarded to the authenticator 306, at 352.

At 356, the authenticator layer 306 may perform a final verification on the response. The authenticator 306 may receive the response from the ISM 308 and perform a final verification to ensure that the response is authorized to be sent back to the client 316 based on the HCS's security policies. In some examples, the ISM 308 may revoke message privileges from an IDC 312, and responses from that IDC 312 may not longer be authorized to be sent to client 316. In another example, the authenticator 306 may check the response for including unauthorized or prohibited information. Authenticator 306 may also log the authorization process and make the logs available for auditing and analysis, for example to ISM 308 or HCS owner or operator.

If the response fails the authorization check, an error response is generated and sent back to the client 316 via the I/O interface 304, at 358. If the Response passes the authorization check, however, authenticator 306 may forward it to the I/O interface 304, at 360.

At 362, the I/O interface 304 may format the response and send it to the client 316. The I/O Interface 304 may receive the authorized response from the authenticator layer 306 and sends it back to the client 316, and potentially may format the response according to the communication protocol used by the HCS (e.g., HTTP(S), (S) FTP, etc.). The response may be sent back to the client 316 via the exposed port, at 364, concluding the request-response cycle. The I/O 304 may also log the response and make the logs available for auditing and analysis. The example process flow at the IDC 312 may be described in greater detail in regard to FIG. 4.

FIG. 4 depicts a flow diagram 400 of an example method to implement a hypercontainer system, in accordance with certain embodiments of the present disclosure. In particular, diagram 400 presents a functional overview of the intelligent data container (IDC) operational architecture, presented through an interaction flow. Diagram 400 may include an intelligent security manager (ISM) 408, I/O interface 402, auth module 404, mini security manager (MSM) 406, and application 410, which may correspond to ISM 208, I/O 202, auth module 204, mini security manager 206, and application 210 of FIG. 2, respectively. The process flow may pick up from step 342 of diagram 300.

At 420, the I/O layer 402 of the IDC may receive the request from either the ISM 408 (single IDC scenario) or the CCM (multiple IDCs scenario). At 422, the I/O layer 402 may structure the request for processing by the Auth layer 404 according to the IDC's internal requirements.

At 424, the I/O layer 402 forwards the structured request to the Auth layer 404 of the IDC. At 426, the Auth layer 404 of the IDC may receive the structured request from the I/O layer 402, and perform a verification operation to ensure that the request has the right authorization to access the specific IDC. This additional authentication step may be useful when the HCS hosts multiple IDCs, as not all users may have access to all IDCs. Accordingly, the auth layer 404 may verify the authorization credentials provided in the request to ensure that the user or client that initiated the request has the right permissions to access the specific IDC. The auth layer 404 may also log the authorization attempts and make the logs available to the MSM 406 for analysis and learning.

If the authorization is invalid, an error response may be generated and sent back to the ISM 408 via the IDC's I/O layer 402, at 428. However, if the authorization of the request is valid, the auth layer 404 may forward the request to the MSM 406 for further processing, at 430.

At 432, the MSM 406 may examine the request. The MSM 406, which may be a miniaturized version of the ISM 408, may receive the authorized request from the Auth layer 404, and examine the request using a combination of symbolic and connectionist AI systems, similar to the ISM 408 but tailored to the specific IDC's requirements. The MSM 406 may evaluate the request against a set of rules and an internal model to ensure the application 410 receives appropriate requests and returns suitable information. If the request is inappropriate or potentially malicious, it may be rejected, logged, and the information is made available to the IDC owner. An error response may be generated and sent back to the ISM 408 via the IDC's Auth 404 and I/O 402 layers, at 434. If the request is deemed appropriate, the MSM 406 may forward it to the application 410 for processing, at 436.

At 438, the application may process the request. The application 410, which may be the application hosted within the IDC, may receive the request from the MSM 406. The application 410 may process the request according to its specific functionality and generate a response. The application 410 may processes the request according to its specific functionality, which can vary based on the type of application (e.g., RDBMS, AI model training, data lake management, etc.). Application 410 may interact with its internal components (e.g., application components 214 of FIG. 2), such as subroutines, scripts, or additional specialized applications, to generate the appropriate response.

Application 410 may generate a response based on the processed request, and send it back to the MSM 406 for examination, at 440. The MSM 406 may receive the response generated by the application 410 and examine it to ensure that it is appropriate and safe to send back to the ISM 408, at 442. As with requests, MSM 406 may analyze the response using symbolic and connectionist AI systems to ensure that it is appropriate and does not contain any sensitive information or potential vulnerabilities. MSM 406 may log the response and update its internal model for continuous learning and improvement.

If the MSM 406 determines the response is inappropriate or potentially harmful, it may be rejected, logged, and the information made available to the IDC owner or operator. An error response may be generated and sent back to the ISM 408 via the IDC's Auth 404 and I/O 402 layers, at 444. If, however, the response is deemed appropriate and safe, the MSM 406 may forward it to the Auth layer 404 for further verification, at 446.

At 448, the auth layer 404 of the IDC may receive the response from the MSM 406 and perform a final verification to ensure that the response is authorized to be sent back to the ISM 408 based on the IDC's internal security policies. The auth layer 404 may log the authorization process and make the logs available for auditing and analysis. If the response fails the authorization check, an error response may be generated and sent back to the ISM 408 via the IDC's I/O layer 402, at 450. If the response passes the authorization check, the auth layer 404 may forward to the I/O layer 402 of the IDC, at 452,

At 454, the I/O layer 402 of the IDC may receive the authorized response from the Auth layer 404 and send it back to the ISM 408. Operation may continue from step 344 of diagram 300.

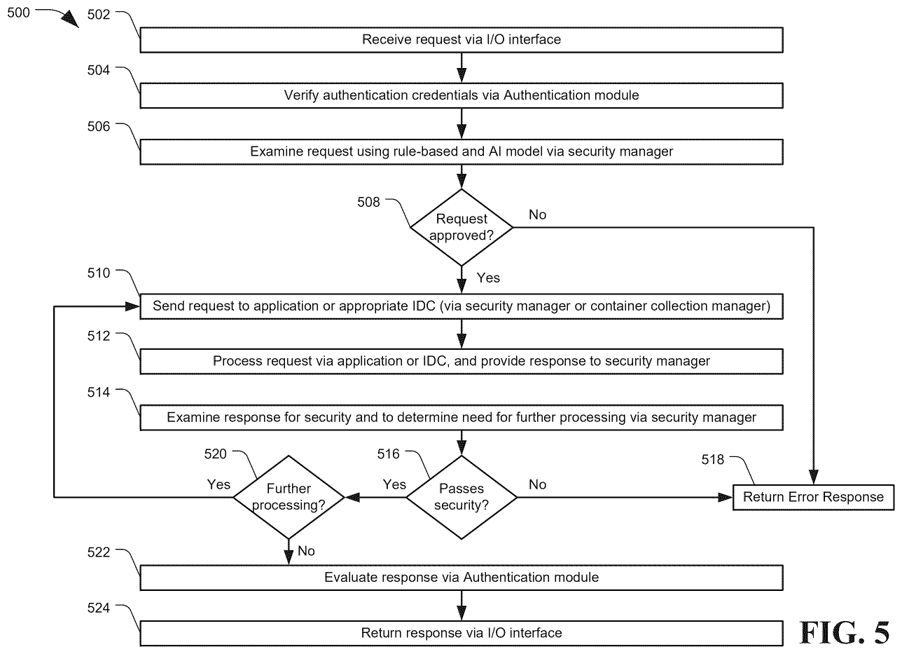

Throughout the process described in regard to FIGS. 3 and 4, the HCS may ensure the security and isolation of the hosted application(s) within the IDC(s) 312. For example, the proposed HCS may provide a secure communication channel between the client 316 and the HCS through the exposed port. The HCS may authenticate and authorize requests at multiple levels (e.g., at both HCS and IDC) to prevent unauthorized access. Further security is provided by utilizing the ISM 308 and mini security manager systems to examine requests and responses for potential security threats and compliance with predefined policies. The HCS may isolate the IDCs 312 and their internal components to minimize the attack surface and prevent potential breaches. Further, by logging all requests, responses, and internal operations, the HCS enables extensive auditing, analysis, and continuous improvement of the system's security and performance. An example method of implementing a hypercontainer system is described in regard to FIG. 5.

FIG. 5 depicts a flowchart 500 of an example method to implement a hypercontainer system, in accordance with certain embodiments of the present disclosure. In particular, flowchart 500 provides an example process for processing requests via an application hosted at an intelligent data container (IDC) of a secure hypercontainer system (HCS) having intelligent security features, as described herein. The HCS and IDC can work together to provide a secure and efficient environment for hosting applications. The IDC may function similarly to the overall HCS in its components, and accordingly the method of FIG. 5 may refer to a request being processed by an HCS, or by an IDC within an HCS. The method of FIG. 5 may be implemented via systems and computing devices such as those depicted in FIG. 1 and FIG. 2.

At 502, the Input/Output (I/O) interface may receive the request, process it, and forwards it to an authentication layer. If the system receiving the request in an HCS, a client may send a request to the HCS via a specific exposed port, which may be the sole access point to the system. If the receiving system is an IDC, the request may be received from an intelligent security manager of an HCS hosting the IDC.

At 504, the authentication layer verifies the authentication credentials and logs the request before forwarding it to an intelligent security manager (ISM) in the case of an HCS, or to a mini security manager (MSM) in the case of an IDC.

At 506, the security manager (ISM or MSM) may examine the request using symbolic and connectionist AI systems to determine if it is safe. At 508, a determination may be made whether the request is approved or otherwise deemed safe for processing. If not, an error message may be returned, such as to the client, to an ISM of the HCS hosting the IDC, the HCS operator, or to other recipients, at 518.

If the request is approved, at 508, the method may include sending the request to an application hosted at the IDC (when the method is being executed by an IDC), or to an appropriate IDC hosted at the HCS (when the method is being executed by an HCS), at 510. In the case of an HCS executing the method, the ISM may use a Container Collection Manager (CCM) to route the request to the appropriate IDC if multiple IDCs are present. Otherwise the ISM may send the request to a sole IDC directly.

At 512, the request may be processed via the internal layers of the IDC (when the method is executed by an HCS), or the request may be processed by the hosted application (when the method is executed by an IDC). After processing, a response may be generated and provided to the security manager (ISM for an HCS, or MSM for an IDC).

The response may be examined by the security manager to ensure it is safe, at 514. In the case of an HCS, the ISM may also determine whether further processing is needed on the response by additional IDCs.

At 516, a determination may be made whether the response passes the security check. If not, an error response may be generated and returned, at 518. If the response does pass the security check, a determination may be made whether further processing is required on the response by additional IDCs (in the case of an HCS performing the method), at 520. If further processing is required, the method may include sending the request to the next appropriate IDC, at 510.

If no further processing is required, the method may include forwarding the response to the authorization layer or module. The authorization module may perform a final verification check on the response, at 522. If the response passes the final verification check, the method may include formatting the response and returning it via the I/O interface, at 524 (e.g., to the ISM of the hosting HCS when the method is performed by an IDC, or returning the response to the client via the exposed port when the method is performed by the HCS).

Throughout the process, the HCS and IDC work together to ensure the security and isolation of the hosted application(s) by authenticating and authorizing requests at multiple levels, examining requests and responses using AI systems, isolating the IDCs and their internal components, and logging all operations for auditing and analysis.

The HyperContainer System's functional flow demonstrates its ability to provide a secure, efficient, and adaptable environment for hosting a wide range of applications while minimizing the attack surface and preventing potential security breaches.

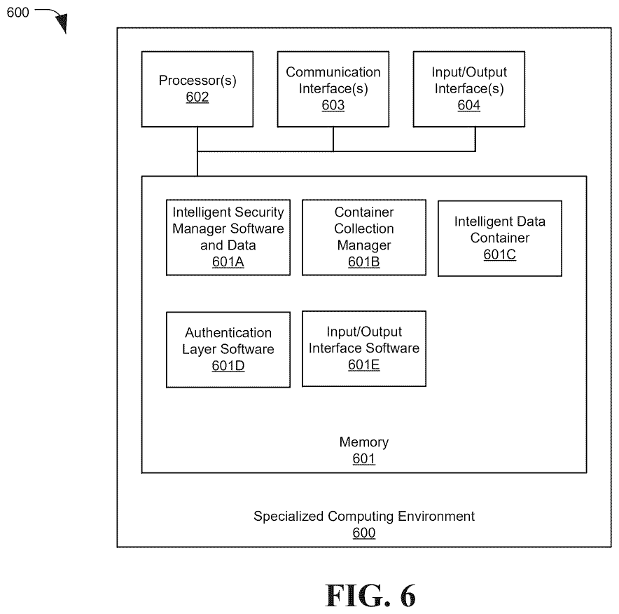

One of the above-described techniques can be implemented in or involve one or more special-purpose computer systems having computer-readable instructions loaded thereon that enable the computer system to implement the above-described techniques. FIG. 6 illustrates an example of a specialized computing environment 600 that can be used to implement the above-described processes according to an exemplary embodiment. The specialized computing environment 600 is not intended to suggest any limitation as to scope of use or functionality of a described embodiment(s).

With reference to FIG. 6, the computing environment 600 may include at least one processing unit or controller 602 and memory 601. The processing unit 602 may execute computer-executable instructions and can be a real or a virtual processor. In a multi-processing system, multiple processing units may execute computer-executable instructions to increase processing power. The memory 601 can be volatile memory (e.g., registers, cache, RAM), non-volatile memory (e.g., ROM, EEPROM, flash memory, etc.), or some combination of the two. The memory 601 can store software and data used for implementing the above-described techniques, including intelligent security manager software and data 601A, container collection manager 601B, intelligent data container 601C, authentication layer software 601D, and input/output interface software 601E.

All of the software stored within memory 601 can be stored as a computer-readable instructions, that when executed by one or more processors 602, cause the processors to perform the functionality described above.

Processor(s) 602 may execute computer-executable instructions and can be a real or virtual processors. In a multi-processing system, multiple processors or multicore processors can be used to execute computer-executable instructions to increase processing power or to execute certain software in parallel.

Specialized computing environment 600 additionally includes a communication interface 603, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 600 further includes input and output interfaces 604 that allow users (such as system administrators) to provide input to the system to set parameters, to edit data stored in memory 601, or to perform other administrative functions.

An interconnection mechanism (shown as a solid line in FIG. 4), such as a bus, controller, or network interconnects the components of the specialized computing environment 600.

Input and output interfaces 604 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 600.

Specialized computing environment 600 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 600.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method comprising:
executing a hypercontainer system including an encapsulated software application environment having built-in intelligent security features, including:
receiving a request for processing by an application hosted at the hypercontainer system in a first intelligent data container (IDC), the first IDC including software container executing the application;
evaluating the request via a mini security manager integrated in the first IDC to determine if the request includes a security threat;
rejecting the request without processing by the application when the request includes the security threat; and
processing the request by the application and returning a response when the request does not include the security threat.

2. The method of claim 1 further comprising:
evaluating the request at the mini security manager using a deterministic rule set for the application.

3. The method of claim 2 further comprising:
evaluating the request at the mini security manager using a machine learning model trained based on normal operating patterns.

4. The method of claim 3 further comprising:
evaluating the request at an authorization layer integrated in the first IDC to determine whether the request is authorized for processing by the application based on credentials included in the request; and
forwarding the request to the mini security manager for evaluation based on the request being authorized for processing.

5. The method of claim 4 further comprising:
determining which of a plurality of IDCs hosted at the hypercontainer system to route the request for processing, each of the plurality of IDCs including its own mini security manager; and
routing the request to the first IDC based on the determination.

6. The method of claim 5 further comprising:
evaluating the request via an intelligent security manager integrated into the hypercontainer system to determine if the request includes a security risk, the intelligent security manager including a large language model (LLM) artificial immune system (AIS); and
routing the request to the first IDC based on determining that the request does not include a security risk.

7. The method of claim 6 further comprising:
receiving the request at the hypercontainer system via a specific exposed port, the specific exposed port being the only path of interfacing with the hypercontainer system;
evaluating the request at an authorization module integrated in the hypercontainer system to determine whether the request is authorized for processing by any IDC hosted at the hypercontainer system based on the credentials included in the request; and
routing the request to the intelligent security manager based on the request being authorized for processing.

8. A memory device storing instructions that, when executed, cause a processor to:
execute a hypercontainer system including an encapsulated software application environment having built-in intelligent security features, including:
receive a request for processing by an application hosted at the hypercontainer system in a first intelligent data container (IDC), the first IDC including software container executing the application;
evaluate the request via a mini security manager integrated in the first IDC to determine if the request includes a security threat;
reject the request without processing by the application when the request includes the security threat; and
process the request by the application and return a response when the request does not include the security threat.

9. The memory device of claim 8 storing instructions that, when executed, cause the processor to further:
evaluate the request at the mini security manager using a deterministic rule set for the application.

10. The memory device of claim 8 storing instructions that, when executed, cause the processor to further:
evaluate the request at the mini security manager using a machine learning model trained based on normal operating patterns.

11. The memory device of claim 8 storing instructions that, when executed, cause the processor to further:
evaluate the request at an authorization layer integrated in the first IDC to determine whether the request is authorized for processing by the application based on credentials included in the request; and
forward the request to the mini security manager for evaluation based on the request being authorized for processing.

12. The memory device of claim 8 storing instructions that, when executed, cause the processor to further:
determine which of a plurality of IDCs hosted at the hypercontainer system to route the request for processing based on a content of the request and a purpose of each of the plurality of the IDCs, each of the plurality of IDCs including its own mini security manager; and
route the request to the first IDC based on the determination.

13. The memory device of claim 8 storing instructions that, when executed, cause the processor to further:
evaluate the request via an intelligent security manager integrated into the hypercontainer system to determine if the request includes a security risk, the intelligent security manager including a large language model (LLM) artificial immune system (AIS); and
route the request to the first IDC based on determining that the request does not include a security risk.

14. The memory device of claim 13 storing instructions that, when executed, cause the processor to further:
receive the request at the hypercontainer system via a specific exposed port, the specific exposed port being the only path of interfacing with the hypercontainer system;
evaluate the request at an authorization module integrated in the hypercontainer system to determine whether the request is authorized for processing by any IDC hosted at the hypercontainer system based on credentials included in the request; and
route the request to the intelligent security manager based on the request being authorized for processing.

15. An apparatus comprising:
a processor; and
a memory device storing instructions that cause the processor to execute a hypercontainer system including an encapsulated software application environment having built-in intelligent security features, including:
receive a request for processing by an application hosted at the hypercontainer system in a first intelligent data container (IDC), the first IDC including software container executing the application;
evaluate the request via a mini security manager integrated in the first IDC to determine if the request includes a security threat;
reject the request without processing by the application when the request includes the security threat; and
process the request by the application and return a response when the request does not include the security threat.

16. The apparatus of claim 15, further comprising the processor configured to execute the instructions to:
evaluate the request at the mini security manager using:
a deterministic rule set for the application; and
a machine learning model trained based on normal operating patterns.

17. The apparatus of claim 15, further comprising the processor configured to execute the instructions to:
evaluate the request at an authorization layer integrated in the first IDC to determine whether the request is authorized for processing by the application based on credentials included in the request; and
forward the request to the mini security manager for evaluation based on the request being authorized for processing.

18. The apparatus of claim 15, further comprising the processor configured to execute the instructions to:
determine which of a plurality of IDCs hosted at the hypercontainer system to route the request for processing based on a content of the request and a purpose of each of the plurality of the IDCs, each of the plurality of IDCs including its own mini security manager; and
route the request to the first IDC based on the determination.

19. The apparatus of claim 15, further comprising the processor configured to execute the instructions to:
receive the request at the hypercontainer system via a specific exposed port, the specific exposed port being the only path of interfacing with the hypercontainer system;
evaluate the request at an authorization module integrated in the hypercontainer system to determine whether the request is authorized for processing by any IDC hosted at the hypercontainer system based on credentials included in the request;
based on the request being authorized for processing, evaluate the request via an intelligent security manager integrated into the hypercontainer system to determine if the request includes a security risk, the intelligent security manager including a large language model (LLM) artificial immune system (AIS); and
route the request to the first IDC based on determining that the request does not include a security risk.

20. The apparatus of claim 15, further comprising:
the hypercontainer system executes using an address range reserved for use exclusively by the hypercontainer system.
